(19) United States
(12) Patent Application Publication
(10) Pub. No.: US 2003/0169894 A1
(43) Pub. Date: Sep. 11, 2003

(54) Electrical contact arrangement for hearing instruments

(76) Inventor: Shin Chai Mark Lin, Millburn, NJ (US)

Correspondence Address: Siemens Corporation, Intellectual Property Department, 186 Wood Avenue South, Iselin, NJ, 08830, US

(21) Appl. No.: 10/092,685

(22) Filed: Mar. 7, 2002

(51) Int. Cl. H04R 25/00

(52) U.S. Cl. 381/323

(57) ABSTRACT

A space-saving electrical contact assembly for a hearing instrument faceplate can be fashioned by physically conforming the configuration of individual contacts to the battery and the battery door in the faceplate. By providing each contact of the assembly with an interconnected terminal, the wiring of the assembly is reduced.

### BACKGROUND OF THE INVENTION

As shown in U.S. Pat. Nos. 5,118,540; 5,799,095; and 6,088,465; incorporated by reference herein, a hearing instrument may be provided with electrical contacts in the faceplate to facilitate programming and adjustment. For in-the-ear hearing instruments, internal space, i.e, within the instrument, is at a premium and the contacts necessarily occupy some portion of this space. To fit properly and comfortably within the user's ear, the size of the instrument must be kept as small as possible.

### BRIEF DESCRIPTION OF THE DRAWINGS

FIGS. 1 and 2 are perspective drawings of a hearing instrument faceplate having a battery receptacle, a microphone, and a programming contact assembly; and

FIGS. 3-5 are perspective views of the individual contacts comprising the programming contact assembly shown in FIG. 1.

### DESCRIPTION OF THE INVENTION

The space required for the electrical contacts can be minimized by physically conforming them to the battery receptacle and door. This arrangement reduces the wiring needed for the hearing instrument and eases manufacturing. Moreover, it permits a smaller volume for the hearing instrument.

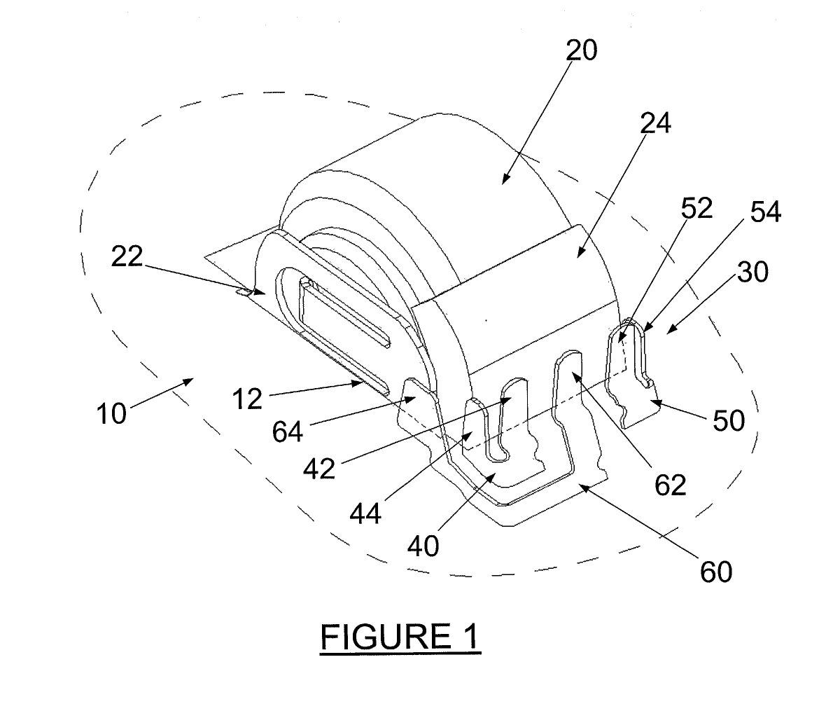

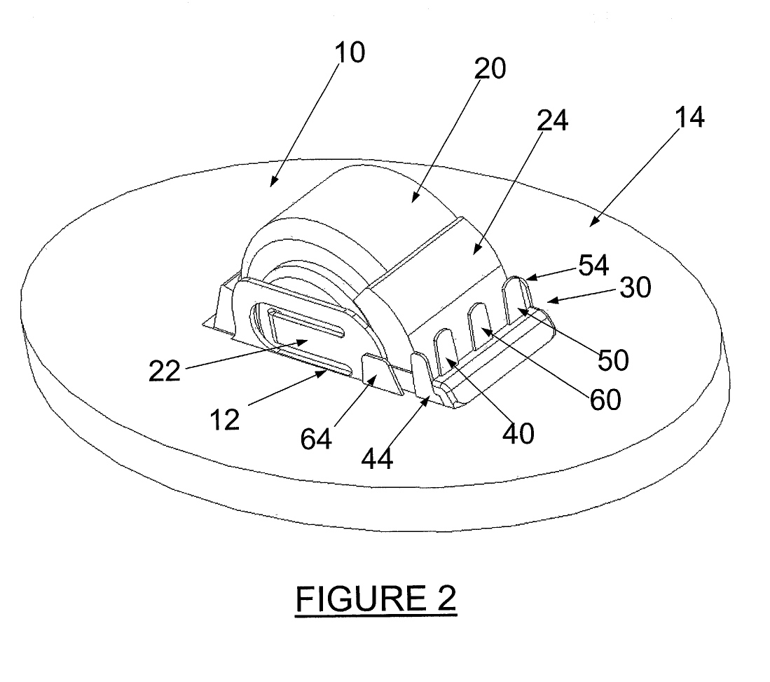

A hearing instrument faceplate 10, a battery 20, a battery door 24, a battery support contact 22, and a programming contact assembly 30 are illustrated in FIG. 1 (illustrating the faceplate in phantom) and FIG. 2. The battery door 24 resides in an opening 12 in the faceplate 10 while the programming contact assembly 30 is adjacent to the battery door 24 and is arranged to generally conform to the door 24. The battery 20, the battery support contacts 22, and the battery door 24 protrude vertically away from the surface 14 of the faceplate 10. Taking note of FIG. 1, it should be understood that this surface 14 would be inside the hearing instrument, the outer surface (not shown) being below.

Although the programming contact assembly 30 shows three distinct contacts 40, 50, and 60, any number of contacts could have been provided. The faceplate 10 can be fabricated by injection molding, during which the battery support contacts 22 and the programming contact assembly 30 are held in place.

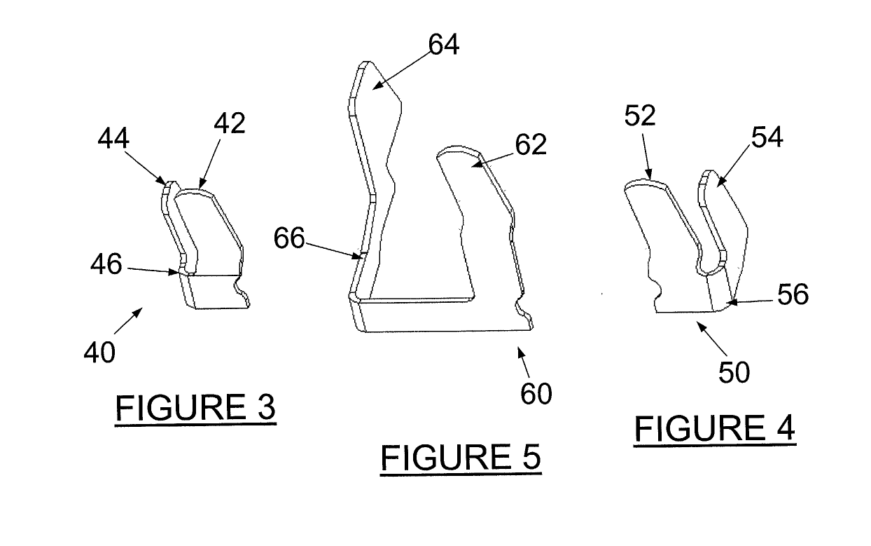

In the particular arrangement shown in FIG. 1, there are two outer contacts 40 and 50, and a center contact 60 which conform to the space adjacent the battery 20 and the battery door 24. As illustrated in the perspective views of FIGS. 3-5, each of the contacts has a contact portion 42, 52, or 62 that lies in a plane generally adjacent the door 24 and a terminal portion 44, 54, or 64, respectively, oriented in a different plane with respect to the corresponding contact portions 42, 52, or 62. In the figures, these planes are roughly at right angles although-other orientations may be used. As illustrated, the contact portions 42, 52, and 62 extend generally vertically from the inner surface 14 of faceplate 10, although tilting or curving somewhat towards the battery door 24. To reach this orientation, it may be necessary to apply pressure to and bend the contact portions 42, 52, and 62 towards the door 24.

The contacts 40, 50, and 60 have intermediate interconnection portions 46, 56, and 66 between the respective contact and terminal portions. As shown in FIG. 1, at least a portion of each of the interconnection portions 46, 56, and 66, and possibly portions of the contact portions 42, 52, and 56, and the terminal portions 44, 54, and 64 are embedded within the faceplate 10.

In the drawings (e.g., FIG. 1), the terminal portion 64 of contact 60 is adjacent the battery support contact 22 and the two items may be either soldered or spot welded together. The other contacts 40 and 50 may be connected to wires (not shown) soldered or spot welded to the respective terminal portions 44 and 54.

The material used to fabricate the contacts 40, 50, and 60 must be flexible enough to allows the contact portions 42, 52, and 62 to flex but not so soft that they will not maintain there general shape during the injection molding process. Beryllium copper and stainless steel have been found to perform satisfactorily.

What is claimed is:

1. A modular assembly for a hearing instrument, comprising:
a faceplate;
a battery door in the faceplate; and
an electrical contact assembly partially affixed to the faceplate and generally adjacent and conforming to the battery door.

2. An assembly as set forth in claim 1, where
the faceplate comprises a generally rectangular opening; and
the battery door resides within the generally rectangular opening.

3. An assembly as set forth in claim 1, where the electrical contact assembly comprises at least one contact, each contact comprising a contact portion and a terminal portion generally adjacent and conforming to the battery door, and an interconnection portion, interconnecting the contact and terminal portions, at least partially embedded in the faceplate.

4. An assembly as set forth in claim 3, where
the faceplate comprises a generally rectangular opening; and
the battery door resides within the generally rectangular opening.

5. An electrical contact assembly for a faceplate of a hearing instrument, where the faceplate comprises a battery door and the assembly is partially affixed to the faceplate and generally adjacent and conforming to the battery door.

6. An assembly as set forth in claim 5, where
the faceplate comprises a generally rectangular opening;
the battery door resides within the generally rectangular opening.

7. An assembly as set forth in claim 5, where the electrical contact assembly comprises at least one contact, each contact comprising a contact portion and a terminal portion generally adjacent and conforming to the battery door, and an interconnection portion, interconnecting the contact and terminal portions, at least partially embedded in the faceplate.

8. An assembly as set forth in claim 7, where
the faceplate comprises a generally rectangular opening;
the battery door resides within the generally rectangular opening.

9. An electrical contact for a faceplate of a hearing instrument, where the faceplate comprises a battery door and the contact is partially affixed to the faceplate and generally adjacent and conforming to the battery door.

10. An electrical contact as set forth in claim 9, where
the faceplate comprises a generally rectangular opening;
the battery door resides within the generally rectangular opening.

11. An electrical contact as set forth in claim 9, where the electrical contact comprises a contact portion and a terminal portion generally adjacent and conforming to the battery door, and an interconnection portion, interconnecting the contact and terminal portions, at least partially embedded in the faceplate.

12. An electrical contact as set forth in claim 11, where
the faceplate comprises a generally rectangular opening;
the battery door resides within the generally rectangular opening.
